(19) United States
(12) Patent Application Publication
(10) Pub. No.: US 2023/0297929 A1
(43) Pub. Date: Sep. 21, 2023

(54) TALENT DEVELOPMENT INFORMATION PROCESSING APPARATUS, TALENT DEVELOPMENT INFORMATION PROCESSING METHOD, AND TALENT DEVELOPMENT INFORMATION PROCESSING PROGRAM

(71) Applicant: R-Square & Company Inc., Tokyo (JP)

(72) Inventor: Takahiro Yamashita, Tokyo (JP)

(21) Appl. No.: 18/202,690

(22) Filed: May 26, 2023

Related U.S. Application Data
(63) Continuation of application No. PCT/JP2021/039144, filed on Oct. 22, 2021.

(30) Foreign Application Priority Data
Nov. 27, 2020 (JP) 2020-197642

(51) Int. Cl. G06Q 10/0639; G06Q 10/0631

(52) U.S. Cl. CPC G06Q 10/06398; G06Q 10/063112

(57) ABSTRACT

A talent development information processing apparatus stores, for each person in charge of business, a piece of information on each person, of performance information indicating business performances achieved by each person, and talent development information indicating talent development status of each person; provides a user with a setting screen for selecting one piece of performance information from the performance information and one piece of talent development information from the talent development information; generates assignment information that assigns the stored information on each person to corresponding quadrant in a matrix configured by four quadrants classified based on the performance and talent development information set on the provided setting screen; stores suggestion information on talent development measures assigned to each quadrant in the matrix; and provides a user with the suggestion information for each person included in the generated assignment information based on the stored suggestion information.

### TECHNICAL FIELD

This disclosure relates to a talent development information processing apparatus, a talent development information processing method, and a talent development information processing program.

### BACKGROUND

Systems that support the sales activities of corporations have been conventionally known. For example, Japanese Laid-Open Patent Publication No. 2010-271809 discloses a system that evaluates the number of times a phrase is used in response contents of a salesperson and the contract rate, and uses this information in sales skill improvement training.

However, the skills required in business activities including sales, are not limited to the response contents but include a variety of activities such as identifying needs, and making proposals to customers, for example. In addition, if the relationship between the various skills possessed by the person in charge of business and the business performances is unclear, the process by which the person in charge of business creates the business performances becomes unclear, and it may fail to be possible to suggest appropriate talent development measures for the person in charge of business.

It could therefore be helpful to provide a talent development information processing apparatus, a talent development information processing method, and a talent development information processing program that are capable of suggesting appropriate talent development measures for a person in charge of business.

### SUMMARY

We thus provide:

(1) A talent development information processing apparatus includes: a first storage unit, which stores, for each person in charge of business, a piece of information on a person in charge of business, a plurality of pieces of performance information indicating business performances achieved by the person in charge of business, and a plurality of pieces of talent development information indicating talent development status of the person in charge of business; a setting screen providing unit, which provides a user with a setting screen for selecting one piece of performance information from among the plurality of pieces of performance information and one piece of talent development information from among the plurality of pieces of talent development information; an assignment information generation unit, which generates assignment information that assigns the information on the person in charge of business stored in the first storage unit to corresponding quadrant in a matrix configured by four quadrants classified based on the performance information and talent development information set on the setting screen provided by the setting screen providing unit; a second storage unit, which stores suggestion information on talent development measures assigned to each quadrant in the matrix; and a suggestion information providing unit, which provides a user with the suggestion information for the person in charge of business included in the assignment information generated by the assignment information generation unit based on the suggestion information stored in the second storage unit.

(2) The first storage unit may store, as the talent development information, at least one piece of the skill information indicating acquisition status of business skills required to achieve a task, or training information indicating implementation status of training to improve the business skills.

(3) The first storage unit may store detailed performance information as the performance information, which represents details of the business performances, and detailed talent development information as the talent development information, which represents the details of the talent development status, and the setting screen providing unit may provide a setting screen, which allows the user to select the detailed performance information and the detailed talent development information.

(4) A list generation unit may be further provided, which may generate a list of the persons in charge of business classified in the same quadrant in the matrix based on the assignment information generated by the assignment information generation unit, and the suggestion information providing unit may provide the suggestion information to the person in charge of business included in the list generated by the list generation unit based on the suggestion information stored in the second storage unit.

(5) The second storage unit may store, as the suggestion information, at least one piece of recommended information for the person in charge of business from among information on training, information on coaching received from others, information on business of which the person is in charge, information on industry of which the person is in charge, or information on sales tools, and the suggestion information providing unit may provide the recommended information stored in the second storage unit.

(6) A computation unit may be further provided, which may compute correlation between the business performances and the talent development status based on the performance information and the talent development information stored in the first storage unit, and the suggestion information providing unit may further provide the user with correlation information on the correlation computed by the computation unit.

(7) A change information generation unit may be further provided, which may generate change information that indicates changes in the assignment information of each person in charge of business over time based on the assignment information generated by the assignment information generation unit, and the suggestion information providing unit may provide the suggestion information based further on the change information of another person in charge of business generated by the change information generation unit.

(8) The first storage unit may store attribute information that indicates attributes of the person in charge of business as the information on the person in charge of business, and the suggestion information providing unit may provide the suggestion information based further on the performance information and the talent development information of another person in charge of business having information on attributes similar to those of the person in charge of business.

(9) A talent development information processing method in a talent development information processing apparatus, includes: a first storage step for storing, for each person in charge of business, a piece of information on a person in charge of business, a plurality of pieces of performance information indicating business performances achieved by the person in charge of business, and a plurality of pieces of talent development information indicating talent development status of the person in charge of business; a setting screen providing step for providing a user with a setting screen for selecting one piece of performance information from among the plurality of pieces of performance information and one piece of talent development information from among the plurality of pieces of talent development information; an assignment information generation step for generating assignment information that assigns the information on the person in charge of business stored in the first storage step to corresponding quadrant in a matrix configured by four quadrants classified based on the performance information and talent development information set on the setting screen provided in the setting screen providing step; a second storage step for storing suggestion information on talent development measures assigned to each quadrant in the matrix; and a suggestion information providing step for providing a user with the suggestion information for the person in charge of business included in the assignment information generated in the assignment information generation step based on the suggestion information stored in the second storage step.

(10) A talent development information processing program causes a computer to perform: a first storage process for storing, for each person in charge of business, a piece of information on a person in charge of business, a plurality of pieces of performance information indicating business performances achieved by the person in charge of business, and a plurality of pieces of talent development information indicating talent development status of the person in charge of business; a setting screen providing process for providing a user with a setting screen for selecting one piece of performance information from among the plurality of pieces of performance information and one piece of talent development information from among the plurality of pieces of talent development information; an assignment information generation process for generating assignment information that assigns the information on the person in charge of business stored in the first storage process to corresponding quadrant in a matrix configured by four quadrants classified based on the performance information and talent development information set on the setting screen provided in the setting screen providing process; a second storage process for storing suggestion information on talent development measures assigned to each quadrant in the matrix; and a suggestion information providing process for providing a user with the suggestion information for the person in charge of business included in the assignment information generated in the assignment information generation process based on the suggestion information stored in the second storage process.

A talent development information processing apparatus stores, for each person in charge of business, a piece of information on a person in charge of business, a plurality of pieces of performance information indicating business performances achieved by the person in charge of business, and a plurality of pieces of talent development information indicating talent development status of the person in charge of business; provides a user with a setting screen for selecting one piece of performance information from among the plurality of pieces of performance information and one piece of talent development information from among the plurality of pieces of talent development information; generates assignment information that assigns the stored information on the person in charge of business to corresponding quadrant in a matrix configured by four quadrants classified based on the performance information and talent development information set on the provided setting screen; stores suggestion information on talent development measures assigned to each quadrant in the matrix; and provides a user with the suggestion information for the person in charge of business included in the generated assignment information based on the stored suggestion information. This suggests appropriate talent development measures for a person in charge of business.

### BRIEF DESCRIPTION OF THE DRAWINGS

FIG. 1 is a block diagram illustrating an example of a software configuration of a talent development information processing apparatus according to an example.

FIG. 2 is a diagram illustrating an example of a data table used in the talent development information processing apparatus according to the example.

FIG. 3 is a diagram illustrating an example of a setting screen used in the talent development information processing apparatus according to the example.

FIG. 4 is a diagram illustrating a first example of assignment information used in the talent development information processing apparatus according to the example.

FIG. 5 is a diagram illustrating a second example of the assignment information used in the talent development information processing apparatus according to the example.

FIG. 6 is a diagram illustrating an example of a list of persons in charge of business used in the talent development information processing apparatus according to the example.

FIG. 7 is a diagram illustrating an example of suggestion information used in the talent development information processing apparatus according to the example.

FIG. 8 is a block diagram illustrating an example of a hardware configuration of the talent development information processing apparatus according to the example.

FIG. 9 is a flowchart illustrating an example of operations of the talent development information processing apparatus according to the example.

### DESCRIPTION OF THE REFERENCE NUMERALS

1: training measure information processing apparatus
11: first storage unit
12: second storage unit
13: setting screen providing unit
14: assignment information generation unit
15: list generation unit
16: computation unit
17: change information generation unit
18: suggestion information providing unit
2: user terminal
21: web browser
9: network
101: CPU
102: RAM
103: ROM
104: I/O device
105: communication OF
1000: data table
1001: performance information
1002: skill information
1003: training information
2000: setting screen
2001: pull-down menu
2002: pull-down menu
2011: ZONE A
2012: ZONE B
2013: ZONE C
2014: ZONE D
2021: performance information
2022: skill information
2101: detailed performance information
2201: detailed training information
3000: assignment information
3011: first quadrant
3012: second quadrant
3013: third quadrant
3014: fourth quadrant
4000: assignment information
4011: first quadrant
4012: second quadrant
4013: third quadrant
4014: fourth quadrant
5000: list
5001: list
5002: list
5003: list
5004: list
6000: suggestion information
6001: training measures
6002: training measures
6003: training measures
6004: training measures

### DETAILED DESCRIPTION

Hereinafter, with reference to the drawings, a talent development information processing apparatus, a talent development information processing method, and a talent development information processing program according to one example will be described in detail.

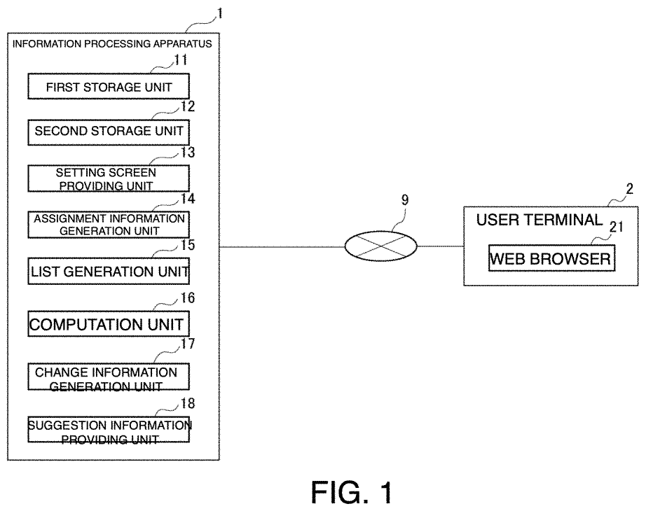

First, with reference to FIG. 1, the functions of the talent development information processing apparatus will be described. FIG. 1 is a block diagram illustrating an example of the software configuration of the talent development information processing apparatus according to the example.

In FIG. 1, a talent development information processing apparatus 1 is connected to a user terminal 2 via a network 9 in a communicationable manner. The user terminal 2 is directed to a terminal operated by a user that uses the talent development information processing apparatus 1. The term “user” may be directed to either a single user or plural users. For example, when the ID for using the talent development information processing apparatus 1 is shared by multiple people, the user is directed to any person that uses the ID to use the talent development information processing apparatus 1. FIG. 1 merely illustrates a connection destination of the talent development information processing apparatus 1, and does not limit the connection destination of the talent development information processing apparatus 1. For example, the talent development information processing apparatus 1 may be connected to multiple user terminals 2. The network 9 is directed to a wired or wireless network, for example, the Internet.

The talent development information processing apparatus 1 includes functional units, i.e., a first storage unit 11, a second storage unit 12, a setting screen providing unit 13, an assignment information generation unit 14, a list generation unit 15, a computation unit 16, a change information generation unit 17, and a suggestion information providing unit 18. Each of the functional units of the talent development information processing apparatus 1 above in this example is described as a functional module comprising the talent development information processing program (software) in this example.

The first storage unit 11 stores information on a person in charge of business, a plurality of pieces of performance information, and a plurality of pieces of talent development information for each person in charge of business.

The information on the person in charge of business is directed to the information on the person that is in charge of business. The information on the person in charge of business may include, for example, the name of the person in charge of business, ID (e.g., a number to identify the person in charge of business), icon (e.g., a graphic or image to identify the person in charge of business), name of the superior, industry of which the person is in charge, date of entering the company, year of entering the company, quadrant to which the person is currently mapped (see below), or educational background. The icon may be displayed in the assignment information described below.

The performance information is directed to information that indicates the business performances achieved by the person in charge of business. The first storage unit 11 may store detailed performance information that represents the details of the business performances as the performance information. The detailed business performance information may include, for example, information on business performances in various industries such as business performances in sales positions, research performances in research positions, development performances in development positions, teaching performances in teaching positions, or military performances in military positions. In this example, when the performance information is directed to business performances is illustrated. For example, the information that indicates detailed performance information in the business performances may include, for example, the business achievement rate, which indicates the achievement rate against the sales targets; the annual amount of created business negotiations, which indicates the amount of business negotiations created throughout the year; the annual number of created business negotiations, which indicates the number of business negotiations created throughout the year; the average amount of created business negotiations, which indicates the average amount of business negotiations created throughout the year; the average number of days of business negotiations, which indicates the number of days required for business negotiations; or the order receipt rate, which indicates the percentage of business negotiations in which the orders have been received. Each person in charge of business may achieve plural tasks. The first storage unit 11 stores multiple pieces of performance information.

The talent development information is directed to information that indicates the talent development status of the person in charge of business. The first storage unit 11 may store the detailed talent development information that indicates the details of the talent development status as the talent development information. The first storage unit 11 stores at least one of skill information and training information as the talent development information.

The skill information is directed to information that indicates the acquisition status of the business skills required to achieve the business. The skill information in the detailed talent development information may include information on, for example, the overall skill evaluation in which the overall skill is evaluated by a numerical value or rank; the account skill evaluation in which the ability to formulate an account plan that summarizes the basic concept of sales for each customer; the hypothesis formulation skill evaluation in which the ability to formulate hypotheses in sales is evaluated; or the business plan proceeding evaluation in which the ability to proceed the business plan is evaluated.

The training information is directed to information that indicates the implementation status of training to improve the business skills. The training information in the detailed talent development information may include, for example, the ratio of completion of training, which indicates the percentage of completed training among multiple training sessions; or the completion flag, which indicates that each training session has been completed. The training information may be directed to, for example, information indicating the implementation status for training suggested (recommended) by the talent development information processing apparatus 1. Alternatively, the training information may be directed to information that indicates the implementation status for all training (including training that is not suggested).

Each person in charge of business may acquire multiple skills or complete multiple training. The first storage unit 11 may store multiple pieces of skill information or training information.

The setting screen providing unit 13 provides the user with a setting screen for selecting one piece of performance information among multiple pieces of performance information and one piece of talent development information among multiple pieces of talent development information. The setting screen providing unit 13 may provide a setting screen allowing the user to select the detailed performance information and detailed talent development information. The assignment information generation unit 14 generates assignment information that assigns the information on person in charge of business stored in the first storage unit 11 to corresponding quadrant in the matrix, which is configured by four quadrants classified based on the performance information and talent development information set on the setting screen provided by the setting screen providing unit 13.

A matrix is a set of regions in which a plane is divided into multiple regions. Each region in the matrix is referred to as a quadrant. In this example, the matrix has four quadrants generated when the performance information and talent development information are set as two coordinate axes perpendicular to each other. Each of the four quadrants is a region characterized by the performance information and talent development information. The setting screen providing unit 13 provides the user with a setting screen for selecting the coordinate axes of the matrix. As mentioned above, the first storage unit may store a plurality of pieces of the performance information. Also, the first storage unit may store multiple pieces of skill information or training information. The setting screen allows the user to select one piece of the performance information among multiple pieces of the performance information as one coordinate axis (e.g., y-axis). The setting screen allows the user to select one piece of information among the multiple pieces of skill information or training information as the other coordinate axis (e.g., x-axis).

The assignment information generation unit 14 generates assignment information that assigns the information on persons in charge of business to the corresponding quadrants in the matrix with the performance information and talent development information set on the setting screen as the respective coordinate axes. Assigning the information on the person in charge of business corresponds to mapping the information on each person in charge of business to the corresponding quadrant of the matrix. The assignment information visualizes (render visible) to which quadrant each person in charge of business has been mapped and in which portion of the mapped quadrant each person in charge of business is located. Even within the same quadrant, the mapping positions in the matrix differ from each other depending on the numerical values of the performance information and talent development information. The assignment information generation unit 14 may represent the difference between the performance information and talent development information of one person in charge of business and those information of another person in charge of business according to the mapping positions of the persons. For example, the assignment information generation unit 14 is capable of representing whether the performance information and talent development information of one person in charge of business is similar to those of the other person in charge of business according to the difference in the mapping positions of the two persons in charge of business in the matrix.

The assignment information generation unit 14 generates the assignment information to facilitate a user to check to which quadrant each person in charge of business has been mapped. In addition, the setting screen providing unit 13 provides the user with the setting screen to facilitate the user to check the assignment information in the performance information and talent development information optionally selected by the user.

The assignment information is generated based on the talent development status of “Enabled” in the skill information and training information, and suggests talent development measures. Accordingly, the assignment information may be referred to as enablement dashboard based on providing the user with the information based on the Enablement.

The second storage unit 12 stores the suggestion information on the talent development measures assigned to the quadrants of the matrix. The suggestion information is directed to information that suggests measures for training a person in charge of business. The suggestion information may include, for example, information on training, coaching, assigned tasks, assigned industries, or sales tools, that are recommended to the person in charge of business.

The information on training is directed to training to train a person in charge of business and may include, for example, the type of training, the duration of the training, the cost of the training, and the location of the training. The information on coaching may include, for example, the type of coaching (e.g., self-development, psychological, or philosophical), the school of coaching (e.g., name of coaching organization, method, and others), and the name of the coach.

The information on the assigned tasks may include, for example, information on sales, accounting, legal, general affairs, research, or development. The information on the assigned tasks may include, for example, information on the specific organizations, superiors or colleagues.

The information on the assigned industries may include, for example, agriculture, forestry, fisheries, mining, construction, manufacturing, communications, services, or advertising. The information on the assigned industries may include, for example, the specific company name, workplace, and working form (e.g., full-time or part-time).

The information on sales tools may include information on tools that support or assist the tasks of the person in charge of business such as management tools that manage customer information (e.g., business card information, and address book information), document creation tools that create presentation materials, and schedulers that manage their own schedules. The information on sales tools may also include electronic media including videos explaining sales know-how, and information on novelty goods to be distributed to customers, for example.

The suggestion information providing unit 18 provides the user with suggestion information for the person in charge of business included in the assignment information generated by the assignment information generation unit 14 based on the suggestion information stored in the second storage unit 12.

The suggestion information providing unit 18 may, for example, provide the user with the suggestion information that is assigned to the corresponding quadrant in the matrix on a one-to-one basis. In addition, the suggestion information providing unit 18 may select one or more pieces of the suggestion information from a plurality of pieces of suggestion information stored in the second storage unit 12 based on the information of other persons in charge of business that have achieved high business performances. For example, the suggestion information providing unit 18 may provide the user with the suggestion information by referring to the suggestion information that has been provided in the past for the information on other persons in charge of business, that have information (e.g., business in charge, and year of joining the company) similar to that of the person in charge of business.

In addition, the suggestion Information providing unit 18 may use artificial intelligence (AI) to select one or more pieces of the suggestion information from a plurality of pieces of the suggestion information stored in the second storage unit 12 and provide it to the user. The talent development information processing apparatus 1 in this example may update and store the performance information of the person in charge of business as appropriate. For example, the results of the computation of the correlation computed by the computation unit 16 described below may be accumulated every time the performance information is updated. For example, the suggestion information providing unit 18 may operate the AI to select the suggestion information provided to each person in charge of business, and the suggestion information with high correlation using the subsequent performance information and the correlation information as learning data to provide the user with the suggestion information.

Providing the suggestion information is directed to, for example, generating a web site that contains suggestion information and displaying the generated web site to the web browser 21 of the user terminal 2. The suggestion information may be provided by sending an email including the suggestion information to the user terminal 2. The suggestion information providing unit 18 may provide the suggestion information for a single person in charge of business, or the suggestion information for multiple persons in charge of business. For example, if the user is the superior of several persons in charge of business, the suggestion information providing unit 18 may provide the suggestion information for the subordinates of the user.

The list generation unit 15 generates a list of persons in charge of business classified in the same quadrant in the matrix based on the assignment information generated by the assignment information generation unit 14. The suggestion information providing unit 18 provides the suggestion information to the person in charge of business included in the list generated by the list generation unit 15 based on the suggestion information stored in the second storage unit 12. For example, a list of the persons in charge of business displays the name of each person in charge of business and the performance information and talent development information of the person in charge of business in a list format. The list of persons in charge of business classified in the same quadrant in the matrix is generated to allow a user to check which person in charge of business has similar performance information and talent development information.

The computation unit 16 computes the correlation between the business performances and talent development status based on the performance information and talent development information stored in the first storage unit 11. The suggestion information providing unit 18 further provides the user with the correlation information on the correlation computed by the computation unit 16.

As mentioned above, since the talent development measures include a significant number of measures, it may be difficult to determine which measures will contribute to the achievement of the business performances. The computation unit 16 is capable of computing the correlation between the business performances and the talent development status (e.g., correlation coefficient, or presence or absence of significant difference), facilitating the user to determine which measures will contribute to achieving the business performances. In this example, the persons in charge of business are mapped in the assignment information, for example, allowing the computation unit 16 to compute the correlation between the business performances and the talent development status of the persons in charge of business mapped to the same quadrant in the matrix.

The change information generation unit 17 generates change information that indicates changes in the assignment information of each person in charge of business over time based on the assignment information generated by the assignment information generation unit 14. The suggestion information providing unit 18 provides suggestion information based further on the change information of other persons in charge of business generated by the change information generation unit 17.

The assignment information indicates the current mapping position based on the performance information and talent development information of the person in charge of business. The position of the mapping in the assignment information changes over time depending on the subsequent talent development measures taken by the person in charge of business and other factors. The information on changes in the assignment information is generated, for example, as the amount of change in the numerical values of the performance information and talent development information, the amount of change in the coordinates on the mapped matrix, or the locus of the coordinates on the matrix. The change information generation unit 17 generates the change information generated on a monthly or annual basis, for example, allowing the suggestion information providing unit 18 to search for other persons in charge of business (e.g., senior persons in charge) that have similar change information and provide suggestion information referring to the talent development measures implemented by the other persons in charge of business.

The functional units of the talent development information processing apparatus 1 described above merely illustrate examples of the functional units of the talent development information processing apparatus 1, and do not limit the functions that the talent development information processing apparatus 1 has. For example, the talent development information processing apparatus 1 need not have all of the above functional units, but may have some of them. The talent development information processing apparatus 1 may also have functions other than those described above. For example, the talent development information processing apparatus 1 may have an input function to input information and an output function to report the operating status of the apparatus by LED lamps or other means.

The functional units of the talent development information processing apparatus 1 are described above as comprising software. However, at least one or more of the above functional units of the talent development information processing apparatus 1 may be comprised by hardware.

Any of the above functional units of the talent development information processing apparatus 1 may be implemented by dividing one functional unit into multiple functional units. In addition, any two or more of the above functional units of the talent development information processing apparatus 1 may be integrated into a single functional unit for implementation. FIG. 1 is a diagram illustrating the functions of the talent development information processing apparatus 1 by functional blocks, and does not show, for example, that each functional unit may be configured by a corresponding separate program file.

The talent development information processing apparatus 1 may be directed to an apparatus comprising a single housing or a system comprising multiple devices connected via a network or other means. For example, the talent development information processing apparatus 1 may have some or all of its functions comprising other virtual devices such as a cloud service provided by a cloud computing system. The talent development information processing apparatus 1 may have at least one or more of the above functional units comprising other devices. That is, the talent development information processing apparatus 1 may correspond to a system configured by multiple devices. The talent development information processing apparatus 1 may be a general-purpose computer such as a desktop PC, or a dedicated device with limited functionality.

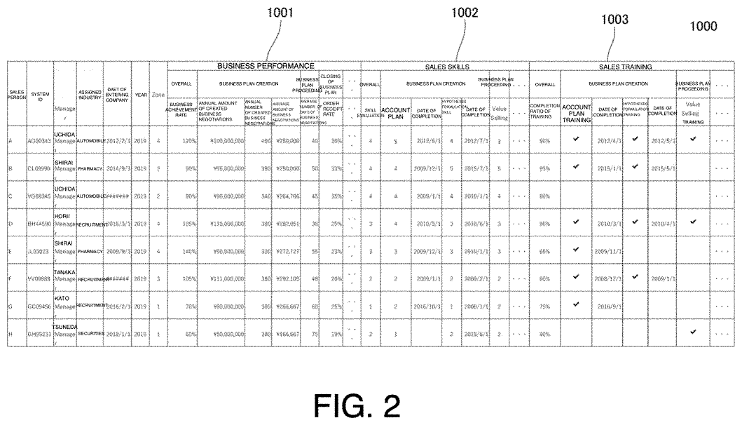

Next, with reference to FIG. 2, a data table will be described. FIG. 2 is a diagram illustrating an example of a data table used in the talent development information processing apparatus 1 according to an example.

In FIG. 2, a data table 1000 displays information on the person in charge of business, performance information 1001, skill information 1002, and training information 1003, which are stored in the first storage unit 1 described in FIG. 1 in a list format for each person in charge of business. The data table 1000 displays a relational database where each column shows the information on each person in charge of business, the performance information, and the talent development information for the person in charge of business.

The data table 1000 includes, as the information on the person in charge of business, the name of the person in charge of business, ID (such as a number to identify the person in charge), the name of the superior, the industry of which the person is in charge, date of entering the company, year of entering the company, and the quadrant to which the person in charge is currently mapped (in this example, it may be referred to as “ZONE”).

The performance information 1001 (shown as “BUSINESS PERFORMANCE” in FIG. 2) may include information such as the business achievement rate, which indicates the achievement rate against the sales targets; the annual amount of created business negotiations, which indicates the amount of business negotiations created throughout the year; the annual number of created business negotiations, which indicates the number of business negotiations created throughout the year; the average amount of created business negotiations, which indicates the average amount of business negotiations created throughout the year; the average number of days of business negotiations, which indicates the number of days required for business negotiations; or the order receipt rate, which indicates the percentage of business negotiations in which the orders have been received.

The skill information 1002 (shown as “SALES SKILLS” in FIG. 2) may include the overall skill evaluation in which the overall skill is evaluated by a numerical value or rank; the account skill evaluation in which the ability to formulate an account plan that summarizes the basic concept of sales for each customer; the hypothesis formulation skill evaluation in which the ability to formulate hypotheses in sales is evaluated; or the business plan proceeding evaluation in which the ability to proceed the business plan is evaluated.

The training information 1003 (shown as “SALES TRAINING” in FIG. 2) may include the training completion rate, which indicates the percentage of training that has been completed among multiple trainings, the completion flag (displayed as a tick mark) for training, which enhances the ability to formulate an account plan, the completion flag (displayed as a tick mark) for training, which enhances the ability to formulate hypotheses in sales, and the completion flag (displayed as a tick mark) for training, which enhances the ability to proceed the business plan.

The contents of the data table 1000 are updated as appropriate when the business information, skill information, or training information is changed. The update of the data table 1000 may be performed, for example, by updating (editing) the contents of the data table 1000 through the user terminal 2. Although the data table 1000 is described when it is displayed in a single tabular format above, for example, each record data (horizontal column data) or field data (vertical row data) may be managed in multiple databases. For example, the record data of a person in charge for each industry may be managed in a separate database, and the data may be merged as the training information 1003. In addition, each field data of the performance information 1001, skill information 1002, and training information 1003 is managed by a separate database, and the data may be merged as the training information 1003.

The data table 1000 may be referred to as an enablement skill map based on a fact that it visualizes what the person in charge of business is able to do (Enablement).

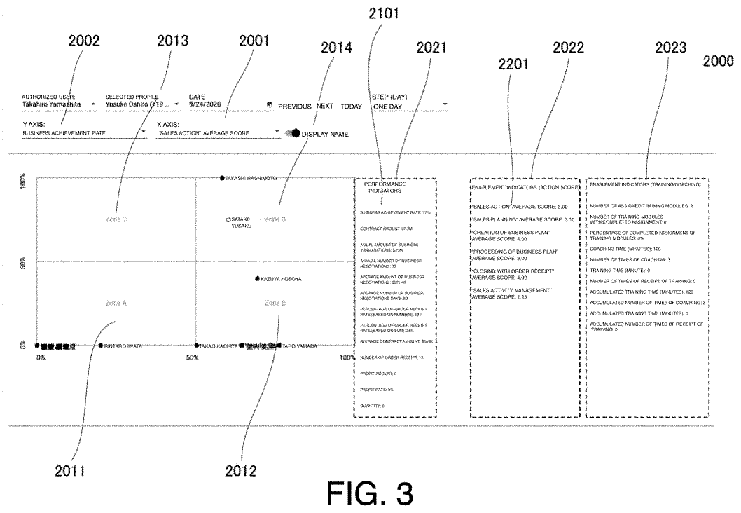

Next, with reference to FIG. 3, a setting screen will be described. FIG. 3 is a diagram illustrating an example of a setting screen used in the talent development information processing apparatus 1 according to an example. In FIG. 3, the setting screen 2000 is directed to a user interface (UI) provided by the setting screen providing unit 13, for example, a display screen that is displayed on the web browser 21.

The setting screen 2000 includes a pull-down menu 2001 for selecting the x-axis (horizontal axis) of the assignment information, and a pull-down menu 2002 for selecting the y-axis (vertical axis) of the assignment information. The pull-down menu 2002 corresponds to a user interface UI for selecting one piece of the performance information from plural pieces of performance information 2021 (labeled “PERFORMANCE INDICATORS” in FIG. 3). FIG. 3 shows that among a plurality of pieces of performance information 2021, the detailed performance information of sales achievement rate 2101 is selected as the y-axis.

In addition, the pull-down menu 2001 corresponds to a user interface UI for selecting a piece of training information from among multiple pieces of skill information 2022 (shown as “ENABLEMENT INDICATORS (ACTION SCORE)” in FIG. 3) or training information 2023 (shown as “ENABLEMENT INDICATORS (TRAINING/COACHING)” in FIG. 3). FIG. 3 shows that, in the multiple pieces of the skill information 2022 or training information 2023, the detailed training information 2201 of sales action is selected as the x-axis. In the pull-down menu 2001, one piece of the training information 2023 may be selected as the detailed training information.

In addition, the setting screen 2000 includes assignment information including a matrix of four quadrants: ZONE A2011, ZONE B2012, ZONE C2013 and ZONE D2014. The assignment information configures four quadrants in the x-axis and y-axis selected in the pulldown menu 2001 and pull-down menu 2002. An icon (mark) and a name (pseudonym is used in FIG. 3) are assigned, as the information on the person in charge of business, to each of the four quadrants ZONE A2011 to ZONE D2014 to identify the person in charge of business (plotted in the coordinates in the matrix). The setting screen 2000 includes the assignment information, allowing the user to select the x-axis and y-axis of the assignment information in the assignment information as well as interactively (in dialogue) check the assignment information generated in the selected x-axis and y-axis.

The setting screen 2000 may also show changes in the assignment information over time. Since the contents of the data table 1000 may be appropriately changed over time as described above, the assignment information may be changed over time as well. The setting screen 2000 may change the assignment information based on the contents of the data table 1000 at a certain date and time. The setting screen 2000 displays changes in the assignment information over time by changing the assignment information in a step of one day. The setting screen 2000 may display the assignment information for each step, for example, one week, ten days, one month, half a month, or one year.

The setting screen 2000 may also have a setting unit for setting whether to generate the list of persons in charge of business to be generated by the list generation unit 15, whether to compute the correlation to be computed by the computation unit 16, or whether to generate the change information to be generated by the change information generation unit 17.

FIG. 3 is described in an example in which both the icon for identifying the person in charge of business and the name of the person in charge of business are displayed in the assignment information. However, the setting screen 2000 may be set to fail to display the name of the person in charge of business. The name of the person in charge of business fails to be displayed to allow the personal information to be protected.

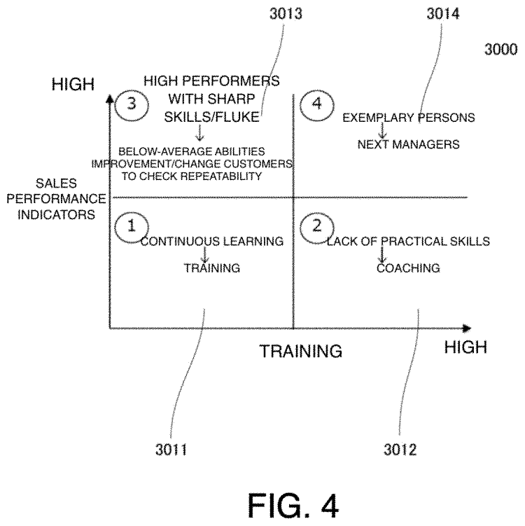

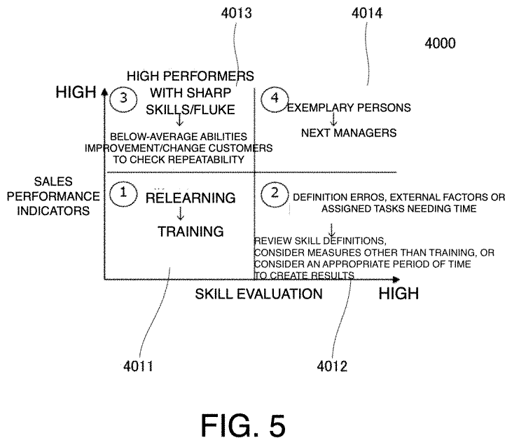

Next, with reference to FIGS. 4 and 5, the assignment information will be described in detail. FIG. 4 is a diagram illustrating a first example of the assignment information used in the talent development information processing apparatus 1 according to an example.

In FIG. 4, the assignment information 3000 includes a first quadrant 3011, a second quadrant 3012, a third quadrant 3013, and a fourth quadrant 3014. The assignment information 3000 suggests the talent development measures in the four quadrants when “TRAINING” as the training information is on the x-axis and “SALES PERFORMANCE INDICATORS” as the performance information is on the y-axis.

To the first quadrant 3011, persons in charge of business, that have less training experience and have characteristics of low sales performance indicators are assigned. The assignment information 3000 corresponds to information for recommending that the persons in charge of business assigned to the first quadrant 3011 may be trained through training since continuous learning is needed.

To the second quadrant 3012, persons in charge of business, that have more training experience and characteristics of low sales performance indicators are assigned. The assignment information 3000 corresponds to information for recommending that the persons in charge of business assigned to the second quadrant 3012 may be trained through coaching because of a lack of practical skills.

To the third quadrant 3013, persons in charge of business, that have less training experience and characteristics of high sales performance indicators are assigned. The assignment information 3000 corresponds to information to recommend training for the persons in charge of business assigned to the third quadrant 3013 to change the customers they are assigned to and check their repeatability, or to recommend talent development measures to improve their below-average abilities since the persons in charge of business assigned to the third quadrant 3013 may be high-performers (genius types) with sharp skills or may have achieved the sales performances by a fluke.

To the fourth quadrant 3014, persons in charge of business, that have significant training experiences and characteristics with high business performance indicators are assigned. The persons in charge of business assigned to the fourth quadrant 3014 correspond to exemplary persons in charge of business. The assignment information for the persons in charge of business assigned to the fourth quadrant 3014 may include information to recommend the sharing of best practices of the exemplary persons in charge of business and the implementation of their training as the next managers, for example.

FIG. 5 is a diagram illustrating a second example of the assignment information used in the talent development information processing apparatus 1 according to an example.

In FIG. 5, the assignment information 4000 includes a first quadrant 4011, a second quadrant 4012, a third quadrant 4013, and a fourth quadrant 4014. The assignment information 4000 suggests the talent development measures in the four quadrants when “SKILL EVALUATION” as the skill information is on the x-axis and “SALES PERFORMANCE INDICATORS” as the performance information is on the y-axis.

To the first quadrant 4011, persons in charge of business, that have low skill evaluation and have characteristics of low sales performance indicators are assigned. The assignment information 4000 corresponds to information for recommending that the persons in charge of business assigned to the first quadrant 4011 may be trained through training since relearning is needed.

To the second quadrant 4012, persons in charge of business, that have high skill evaluation and characteristics of low sales performance indicators are assigned. The assignment Information 4000 corresponds to information to recommend that the persons in charge of business assigned to the second quadrant 4012 may review skill definitions, consider measures other than the talent development measures, or consider an appropriate period of time to create results since reasons may be considered such as errors in the skill definitions, failure to create results due to external factors, or taking considerable time to create results for winning large corporations, for example. Measures other than training may include, for example, sales support measures other than training through advertising and promotional activities; department transfers; job changes; and resignations.

To the third quadrant 4013, persons in charge of business, that have low skill evaluation and have characteristics of high sales performance indicators are assigned. The assignment information 4000 corresponds to information to recommend training for the persons in charge of business assigned to the third quadrant 4013 to change the customers they are assigned to and check their repeatability, or to recommend talent development measures to improve their below-average abilities since the persons in charge of business assigned to the third quadrant 4013 may have achieved results with specific outstanding abilities or may have achieved the performances by a fluke.

To the fourth quadrant 4014, persons in charge of business, that have high skill evaluation and have characteristics of high sales performance indicators are assigned. The assignment information 4000 corresponds to information to recommend that, since the persons in charge of business assigned to the fourth quadrant 4014 are exemplary persons in charge of business, they may share the best practices of the exemplary persons in charge of business and implement their training as the next managers, for example.

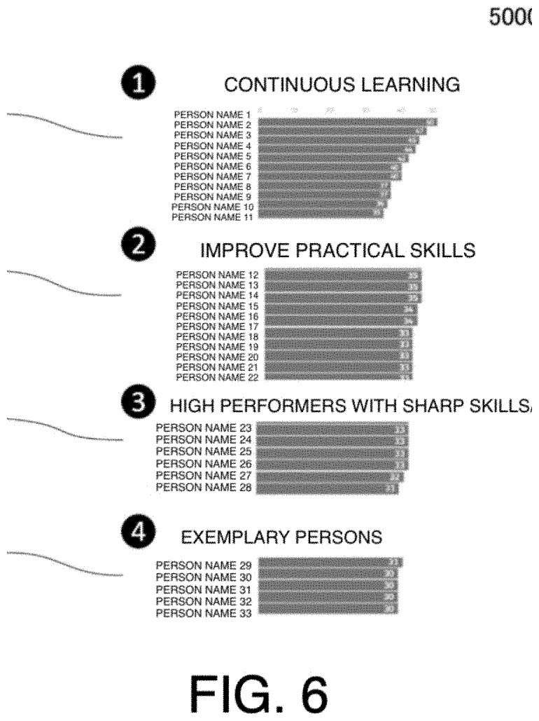

Next, with reference to 6, a list of persons in charge of business will be described in detail. FIG. 6 is a diagram illustrating an example of a list of persons in charge of business used in the talent development information processing apparatus according to an example.

In FIG. 6, the list generation unit 15 generates a list 5000. The list 5000 represents each list of persons in charge of business classified in the same quadrant in the matrix of the assignment information. The list 5000 includes a list 5001, which lists the persons in charge of business assigned to the first quadrant (person names 1 to 11), a list 5002, which lists the persons in charge of business assigned to the second quadrant (person names 12 to 22), a list 5003, which lists the persons in charge of business assigned to the third quadrant (person names 23 to 28), and a list 5004, which lists the persons in charge of business assigned to the fourth quadrant (person names 29 to 33). The lists 5001 to 5004 list the persons in charge of business with the characteristics described in FIGS. 4 and 5. For example, the list 5001 lists the persons in charge of business assigned to the first quadrant in the descending order of their business performance indicators. The indicators indicating the business performances each are shown as the length of a bar graph for each of the person in charge of business.

The persons in charge of business assigned to the same quadrant are listed, controlling the talent development measures for the persons in charge of business. For example, the same training information such as courses is guided to the persons in charge of business assigned to the same quadrant, reducing the man-hours needed to conduct the training.

In addition, the persons in charge of business assigned to the same quadrant are listed, facilitating the user to grasp the effects of the talent development measures. For example, suppose that the persons in charge of business assigned to the same quadrant before the implementation of talent development measures are divided into two groups, and different talent development measures are implemented for each group. If a difference occurs in the business performances of each group after the implementation of the talent development measures, allowing the user to quantitatively recognize the effects of the talent development measures by grasping the correlation between the talent development measures and the business performances.

In addition, the persons in charge of business assigned to the same quadrant are listed, allowing each person in charge of business to be aware of the other persons assigned to the same quadrant as that of her or him, which may improve motivation for the tasks based of a sense of camaraderie or competition.

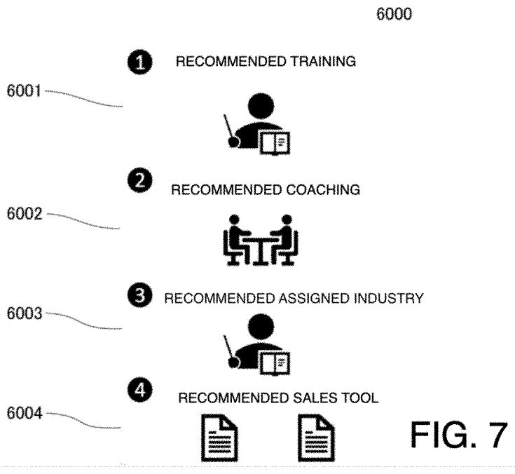

Next, with reference to FIG. 7, the suggestion information will be described in detail. FIG. 7 is a diagram illustrating an example of the suggestion information used in the talent development information processing apparatus 1 according to an example.

The suggestion information 6000 is directed to information that suggests the talent development measures provided by the suggestion information providing unit 18. The suggestion information 6000 represents the talent development measures for the persons in charge of business classified in the same quadrant in the matrix of the assignment information. The suggestion information 6000 may include the talent development measures 6001 for the persons in charge of business assigned to the first quadrant, talent development measures 6002 for the persons in charge of business assigned to the second quadrant, talent development measures 6003 for the persons in charge of business assigned to the third quadrant, and talent development measures 6004 for the persons in charge of business assigned to the fourth quadrant.

The talent development measures 6001 to 6004 are directed to talent development measures for the persons in charge of business with the characteristics described in FIGS. 4 and 5. The talent development measures 6001 to 6004 each have detailed talent development information (not shown). Details of the talent development measures are stored in the second storage unit 12 and are provided by referring to the talent development information of the person in charge of business. For example, if the detailed talent development measures assigned to the talent development measures 6001, which correspond to the first quadrant, are to implement training for L, M, and N, and the person A in charge of business assigned to the first quadrant has already received the training for L and M, the suggestion information providing unit 18 suggests that she or he should take the training for N that has not yet been received. The talent development measures 6002 are directed to detailed talent development measures for coaching information for the persons in charge of business assigned to the second quadrant, the talent development measures 6003 are directed to detailed talent development measures on the assigned industry for the persons in charge of business assigned to the third quadrant, and the talent development measures 6004 are directed to detailed talent development measures on sales tools for the persons in charge of business assigned to the fourth quadrant. The suggestion information 6000 represents the talent development measures for the persons in charge of business classified into the same quadrant in the matrix of the assignment information, facilitating the user to check the talent development measures for persons in charge of business.

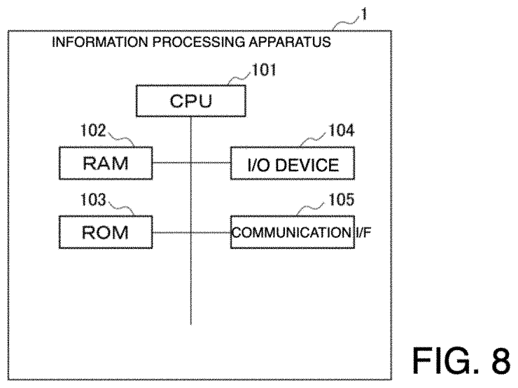

Next, with reference to FIG. 8, the hardware configuration of the talent development information processing apparatus 1 will be described. FIG. 8 is a block diagram illustrating an example of a hardware configuration of the talent development information processing apparatus 1 according to an example.

The talent development information processing apparatus 1 includes: a central processing unit (CPU) 101, a random access memory (RAM) 102, a read only memory (ROM) 103, an input output (I/O) device 104, and communication interface (IF) 105. The talent development information processing apparatus 1 is directed to an apparatus that executes the talent development information processing program described in FIG. 1.

The CPU 101 executes the talent development information processing program stored in the RAM 102 or ROM 103 to control the user terminal. The talent development information processing program is acquired, for example, from a recording medium that stores the program or from a program distribution server via a network, installed in the ROM 3, and read out and executed by the CPU 101.

The I/O device 104 has an operation input function and a display function (operation display function). The I/O device 104 is, for example, a touch panel. The touch panel enables the user of the talent development information processing apparatus 1 to enter the operations using her/his fingertip or touch pen. As the I/O device 104 in this example, a touch panel with an operation display function is used is described. However, the I/O device 104 may have a display device having a display function and an operation input device having an operation input function separate from each other. In this example, the display screen of the touch panel may be implemented as the display screen of the display device, and the operation of the touch panel as the operation of the operation input device. The I/O device 104 may be embodied in various forms such as head-mounted, glasses, and wristwatch displays, for example.

The communication I/F 105 is directed to an OF for communication. The communication I/F 105 performs near field communication such as wireless LAN, wired LAN, and infrared, for example. Although FIG. 8 shows only the communication I/F 105 as the communication I/F, the talent development information processing apparatus 1 may include communication I/Fs respectively corresponding to the multiple communication methods.

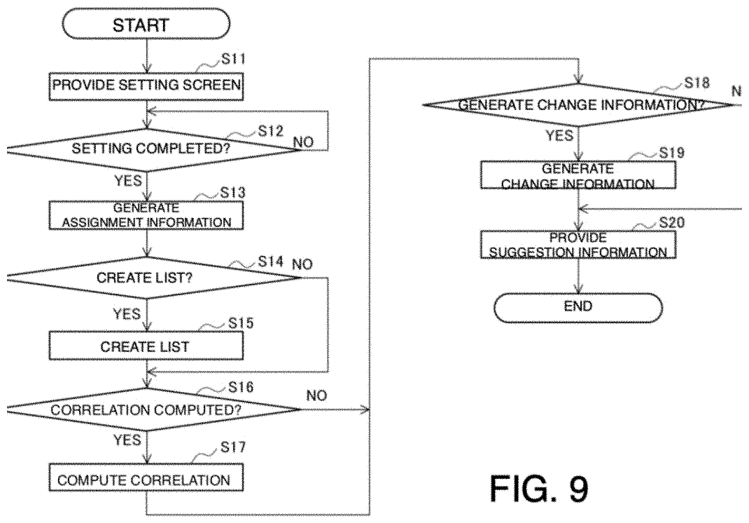

Next, with reference to FIG. 9, the operation of setting the display mode in the talent development information processing apparatus 1 will be described. FIG. 9 is a flowchart illustrating an example of operations of the talent development information processing apparatus 1 according to an example. Although the following flowchart assumes that the entity executing the operations in the flowchart corresponds to the talent development information processing apparatus 1, each operation may be executed by a corresponding functional unit of the talent development information processing apparatus 1 described above.

In FIG. 9, the talent development information processing apparatus 1 provides a setting screen (step S11). The setting screen may be provided by the talent development information processing apparatus 1 providing a web site containing the setting screen.

After executing the process in step S11, the talent development information processing apparatus 1 determines whether the settings on the setting screen have been completed (step S12). Whether the settings on the setting screen have been completed may be determined, for example, based on whether the user has performed the completion operation on the web site. If it is determined that the settings on the setting screen have not been completed (step S12: NO), the talent development information processing apparatus 1 repeats the process in step S12, and waits for the settings on the setting screen to be completed.

In contrast, if it is determined that the settings on the setting screen have been completed (step S12: YES), the talent development information processing apparatus 1 generates the assignment information (step S13). The assignment information generation unit 14 is capable of generating the assignment information.

After executing the process in step S13, the talent development information processing apparatus 1 determines whether to generate a list of persons in charge of business (step S14). The determination on whether to generate a list of persons in charge of business may be made, for example, based on whether the user has set up the list creation in the setting screen. If it is determined that a list of persons in charge of business is to be generated (step S14: YES), the talent development information processing apparatus 1 generates a list of persons in charge of business (step S15). The list generation unit 15 is capable of generating the list of persons in charge of business.

After executing the process in step S15, or if it is determined that the list of persons in charge of business is not to be generated (step S14: NO), the talent development information processing apparatus 1 determines whether to compute the correlation coefficient (step S16). Whether the correlation coefficient is to be computed may be determined, for example, based on whether the user has set the correlation coefficient computation in the setting screen. If it is determined that the correlation coefficient is to be computed (step S16: YES), the talent development information processing apparatus 1 computes the correlation coefficient (step S17). The computation of the correlation coefficients may be performed by the computation unit 16, for example.

After performing the process in step S17, or if it is determined that the correlation is not to be computed (step S16: NO), the talent development information processing apparatus 1 determines whether the change information is to be generated (step S18). Whether the change information is to be generated may be determined, for example, based on whether the user has set the generation of the change information in the setting screen. If it is determined that the change information may be generated (step S18: YES), the talent development information processing apparatus 1 generates the change information (step S19). For example, the generation of the change information may be performed by the change information generation unit 17.

After performing the process in step S19, or if it is determined that no change information may be generated (step S18: NO), the talent development information processing apparatus 1 provides the suggestion information (step S20). The suggestion information may be provided, for example, by the suggestion information providing unit 18 providing a web site to the web browser 21 of the user terminal 2. After performing the process in step S20, the talent development information processing apparatus 1 completes the operation shown in the flowchart.

The flowchart shown in FIG. 9 is an example of the operation of the talent development information processing apparatus 1, and fails to limit the operation of the talent development information processing apparatus 1.

A program that implements the functions configuring the apparatus described in this example may be stored in a computer-readable recording medium, and a computer system may be caused to read and execute the program stored in the recording medium to perform the various processes described above in this example. The phrase “computer system” here may include hardware such as operating systems and peripheral devices. The “computer system” may also include the environment for providing the web site (or the display environment), if the www system is employed. In addition, the phrase “computer readable recording medium” may include flexible disks, optical magnetic disks, ROMs, writable non-volatile memory such as flash memory, a portable media such as CD-ROMs, and storage devices such as hard disks that are built into computer systems.

Further, “a computer readable recording medium” may include any medium that stores programs for a certain period of time such as a volatile memory (e.g., dynamic random access memory DRAM) inside the computer system that serves as a server or client when the program is transmitted over a network such as the Internet or a communication line such as a telephone line. The above program may be transmitted from the computer system that stores the program in a storage device or other device to another computer system via a transmission medium or by transmission waves in the transmission medium. The “transmission medium” that transmits the program refers to a medium that has the function of transmitting information such as a network (communication network) such as the Internet or a communication channel (communication line) such as a telephone line. The program above may also be used to embody some of the functions described above. Furthermore, the functions described above may be combined with the programs that have already stored in the computer system, i.e., difference files (difference programs).

The examples have been described above with reference to the drawings, but the specific configuration is not limited to these examples. Various modifications are also included to the extent that they do not depart from the spirits of the present disclosure.

1. A talent development information processing apparatus comprising:
a first storage unit that stores, for each person in charge of business, a piece of information on a person in charge of business, a plurality of pieces of performance information indicating business performances achieved by the person in charge of business, and a plurality of pieces of talent development information indicating talent development status of the person in charge of business;
a setting screen providing unit that provides a user with a setting screen for selecting one piece of performance information from among the plurality of pieces of performance information and one piece of talent development information from among the plurality of pieces of talent development information;
an assignment information generation unit that generates assignment information that assigns the information on the person in charge of business stored in the first storage unit to corresponding quadrant in a matrix configured by four quadrants classified based on the performance information and talent development information set on the setting screen provided by the setting screen providing unit;
a second storage unit that stores suggestion information on talent development measures assigned to each quadrant in the matrix; and
a suggestion information providing unit that provides a user with the suggestion information for the person in charge of business included in the assignment information generated by the assignment information generation unit based on the suggestion information stored in the second storage unit.

2. The talent development information processing apparatus according to claim 1, wherein the first storage unit stores, as the talent development information, at least one piece of the skill information indicating acquisition status of business skills required to achieve a task, or training information indicating implementation status of training to improve the business skills.

3. The talent development information processing apparatus according to claim 1, wherein the first storage unit stores detailed performance information as the performance information that represents details of the business performances, and detailed talent development information as the talent development information that represents the details of the talent development status, and
the setting screen providing unit provides a setting screen that allows the user to select the detailed performance information and the detailed talent development information.

4. The talent development information processing apparatus according to claim 1, further comprising a list generation unit that generates a list of the persons in charge of business classified in the same quadrant in the matrix based on the assignment information generated by the assignment information generation unit, wherein
the suggestion information providing unit provides the suggestion information to the person in charge of business included in the list generated by the list generation unit based on the suggestion information stored in the second storage unit.

5. The talent development information processing apparatus according to claim 1, wherein the second storage unit stores, as the suggestion information, at least one piece of recommended information for the person in charge of business from among information on training, information on coaching received from others, information on business of which the person is in charge, information on industry of which the person is in charge, or information on sales tools, and
the suggestion information providing unit provides the recommended information stored in the second storage unit.

6. The talent development information processing apparatus according to claim 1, further comprising a computation unit that computes correlation between the business performances and the talent development status based on the performance information and the talent development information stored in the first storage unit, wherein
the suggestion information providing unit further provides the user with correlation information on the correlation computed by the computation unit.

7. The talent development information processing apparatus according to claim 1, further comprising a change information generation unit that generates change information that indicates changes in the assignment information of each person in charge of business over time based on the assignment information generated by the assignment information generation unit, wherein
the suggestion information providing unit provides the suggestion information based further on the change information of another person in charge of business generated by the change information generation unit.

8. The talent development information processing apparatus according to claim 1, wherein the first storage unit stores attribute information that indicates attributes of the person in charge of business as the information on the person in charge of business, and
the suggestion information providing unit provides the suggestion information based further on the performance information and the talent development information of another person in charge of business having information on attributes similar to those of the person in charge of business.

9. A talent development information processing method in a talent development information processing apparatus, the method comprising:
a first storage step of storing, for each person in charge of business, a piece of information on a person in charge of business, a plurality of pieces of performance information indicating business performances achieved by the person in charge of business, and a plurality of pieces of talent development information indicating talent development status of the person in charge of business;
a setting screen providing step of providing a user with a setting screen to select one piece of performance information from among the plurality of pieces of performance information and one piece of talent development information from among the plurality of pieces of talent development information;
an assignment information generation step of generating assignment information that assigns the information on the person in charge of business stored in the first storage step to corresponding quadrant in a matrix configured by four quadrants classified based on the performance information and talent development information set on the setting screen provided in the setting screen providing step;
a second storage step of storing suggestion information on talent development measures assigned to each quadrant in the matrix; and
a suggestion information providing step of providing a user with the suggestion information for the person in charge of business included in the assignment information generated in the assignment information generation step based on the suggestion information stored in the second storage step.

10. A computer readable recording medium storing a talent development information processing program causing a computer to perform:
a first storage process of storing, for each person in charge of business, a piece of information on a person in charge of business, a plurality of pieces of performance information indicating business performances achieved by the person in charge of business, and a plurality of pieces of talent development information indicating talent development status of the person in charge of business;
a setting screen providing process of providing a user with a setting screen to select one piece of performance information from among the plurality of pieces of performance information and one piece of talent development information from among the plurality of pieces of talent development information;
an assignment information generation process of generating assignment information that assigns the information on the person in charge of business stored in the first storage process to corresponding quadrant in a matrix configured by four quadrants classified based on the performance information and talent development information set on the setting screen provided in the setting screen providing process;
a second storage process of storing suggestion information on talent development measures assigned to each quadrant in the matrix; and
a suggestion information providing process of providing a user with the suggestion information for the person in charge of business included in the assignment information generated in the assignment information generation process based on the suggestion information stored in the second storage process.
